(19) United States
(12) Patent Application Publication
(10) Pub. No.: US 2008/0046829 A1
(43) Pub. Date: Feb. 21, 2008

(54) Personalized Book System

(76) Inventor: Annalisa Marie Leong, San Jose, CA (US)

Correspondence Address: QUICKPATENTS, INC., 32861 CALLE PERFECTO, SUITE A, SAN JUAN CAPISTRANO, CA, 92675, US

(21) Appl. No.: 11/839,956

(22) Filed: Aug. 16, 2007

Related U.S. Application Data
(60) Provisional application No. 60/838,115, filed on Aug. 16, 2006.

(51) Int. Cl. G06F 3/048

(52) U.S. Cl. 715/764

(57) ABSTRACT

A system for generating a semi-custom book with a computer and a printer is disclosed. The system includes a plurality of pre-printed pages that are adapted for receiving printed images from the printer. A binding means is adapted to selectively hold each of the plurality of pre-printed pages therein to make the book. The system further includes a computer software program adapted to receive information that is entered by a user into a software template that includes a plurality of software pages corresponding to a common subject, color scheme, theme, or the like. In use, the user is instructed to run the software program on the computer and to enter the information into the software template. Once at least a portion of the information is entered into the software template, the software program allows the user to save the information to a compact data file, or to print the information onto the pre-printed pages. Thereafter, any of the pre-printed pages with the information printed thereon may be selectively inserted into the binding means to make the book. The user may also choose to generate an electronic book file that includes the software pages having any information and at least a portion of the information entered into the software template.

### CROSS-REFERENCE TO RELATED APPLICATIONS

This application claims the benefit of U.S. Provisional Patent Application 60/838,115, filed on Aug. 16, 2006, and is incorporated herein by reference.

### STATEMENT REGARDING FEDERALLY SPONSORED RESEARCH AND DEVELOPMENT

Not Applicable.

### FIELD OF THE INVENTION

This invention relates to books, and more particularly to a system for writing and printing a semi-customized book.

### DISCUSSION OF RELATED ART

Preprinted keepsake journals are one way to collect and record personal information, which focuses on a specific subject. Some examples are:
My Baby's Journal, by Ryland Peters & Small
Destinations: A Travel Journal, by Chronicle Books LLC Staff
40 Weeks+: The Essential Pregnancy Organizer, by Dani Rasmussen and Antoinette Perez

These books provide an individual with questions or thought-provoking commentary to assist them in generating and organizing personal content. These types of books are unappealing to some since the book itself may contain information not relevant to the individual, thus making the final product less personal. In addition, these books require an individual to write using ink or pencil, making it difficult to edit any written information at a later date. Such books and journals also limit the amount of content since the space provided for responses may be too small.

There are some software programs currently available to capture personalized information related to a specific subject. Some examples are:
Personal Author (www.personalauthor.com)
It's My Baby Journal (wwwjournaltek.com)
Family Tree Maker (www.familytreemaker.com)

These software applications offer the user a way to record information, but each has limitations with respect to printing the information. Printing materials are not provided with any of these software programs, thus requiring a user to incur additional cost and inconvenience when trying to find suitable colored or themed paper. Also, the printing output quality, particularly for graphic elements, is limited to the user's printer output capabilities. In addition, such software programs do not offer the user with an electronic version of the book that can be browsed and read on a computer display.

One software program, Flip Album, provides a user with a way to view digital photos or graphical layouts as a virtual book. It provides features such as, automatic layout, addition of annotations and printing of pages created or publication to a website. A printed version of the book created can be achieved using a person's printer, but again, the purchase of more supplies is required

Internet services are available, such as www.Familycookbookproject.com, www.Flipviewer.com, www.photorercord.com and www.photoworks.com. These services help an individual create content for a personalized book on a specific subject. These services usually charge a membership or registration fee. A printed version of a book can be created at additional cost and is delivered to the user via US Mail. This method makes edits to the printed version time consuming and costly since updates need to be paid for, printed, and then mailed when editing or adding any content.

Therefore, there is a need for a system that provides an easy-to-create and easy-to-print semi-custom journal or book. Such a system would provide pre-printed sheets that correspond to a common subject, color scheme, theme, or the like in a computer program, and would allow users to enter personal information as desired into a software template that then may be either printed on the pre-printed sheets or viewed in an easy-to-use software book format. Such a needed system would not require additional fees or excessive delays when printing updates. The present invention accomplishes these objectives.

### SUMMARY OF THE INVENTION

The present device is a system for generating a semi-custom book by utilizing a computer. The system includes a plurality of pre-printed pages that are adapted for receiving printed images from a printer. Such pre-printed pages preferably relate to a common subject, color scheme, theme, or the like.

A binding means is adapted to selectively hold each of the plurality of pre-printed pages therein. The binding means includes at least a front cover, a rear cover, and optionally a spine. Preferably each of the pre-printed pages includes a plurality of binding aperture, each of which cooperate with the binding means to allow the binding means to selectively hold at least two of the pre-printed pages together. The binding means may be, for example, a commonly-available three-ring type binder, or other type of binding means that allows the user to selectively insert and remove any of the pre-printed pages.

The system further includes a computer software program adapted to receive information that is entered by a user into a software template, utilizing the computer, monitor and the at least one input device. The template includes a plurality of software pages corresponding to a common subject, color scheme, theme, or the like and may correspond to the pre-printed pages provided.

In use, the user is instructed to run the software program on the computer and to enter the information into the software template. Once at least a portion of the information is entered into the software template, the software program allows the user to save the information to a compact data file to a storage device of the computer for future retrieval. The software program also allows the user to print the information onto the pre-printed pages. Thereafter, any of the pre-printed pages with the information printed thereon may be selectively inserted into the binding means to make the book.

Alternately, such as in the case where the computer does not have a printer connected thereto, for example, the computer software program allows the user to output the information and software template together into an electronic book file that contains at least a portion of the information entered by the user into the software template. The software program may also allow the user to generate alternate electronic book files that do not correspond to the pre-printed pages, if desired by the user.

Preferably each system comes in a kit format that includes the binding means, the software program, and the pre-printed pages. Each kit may include pre-printed pages and a corresponding software template that pertain to a common subject, color scheme, theme, or the like. As each of the pre-printed pages are selectively removable from the binding means, the resulting book may be a “living document,” that is, a book wherein the information therein can change over time as the user sees fit.

The present invention is a system that provides an easy-to-create and easy-to-print semi-custom journal or book. The present invention provides pre-printed sheets that correspond to a software template in a computer program, and allows users to enter personal information as desired into the software template that then may be either printed on the pre-printed sheets or viewed in an easy-to-use software book format. The inventive system does not require additional fees or result in excessive delays when printing updates. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is flow diagram of a computer software program of the invention;

FIG. 2a is a front elevational view of an example of a pre-printed page of the invention;

FIG. 2b is a front elevational view of an example of the pre-printed page of FIG. 2a, but having some information printed thereon;

FIG. 3a is a front elevational view of an example of an alternate pre-printed page of the invention;

FIG. 3b is a front elevational view of an example of the pre-printed page of FIG. 3a, but having some information printed thereon that includes text and a graphic image;

FIG. 4 is a front elevational view of a binding means having a front cover and a spine of the invention, the binding means being in a closed configuration;

FIG. 5 is a front elevational view of the binding means of FIG. 4 in an open configuration;

FIG. 6 is a diagram of the system of the present invention; and

FIG. 7 is a front elevational view of an electronic book file generated by the software program of the invention and utilizing information entered by the user into the software template, as displayed on a computer monitor.

### DETAILED DESCRIPTION OF THE PREFERRED EMBODIMENT

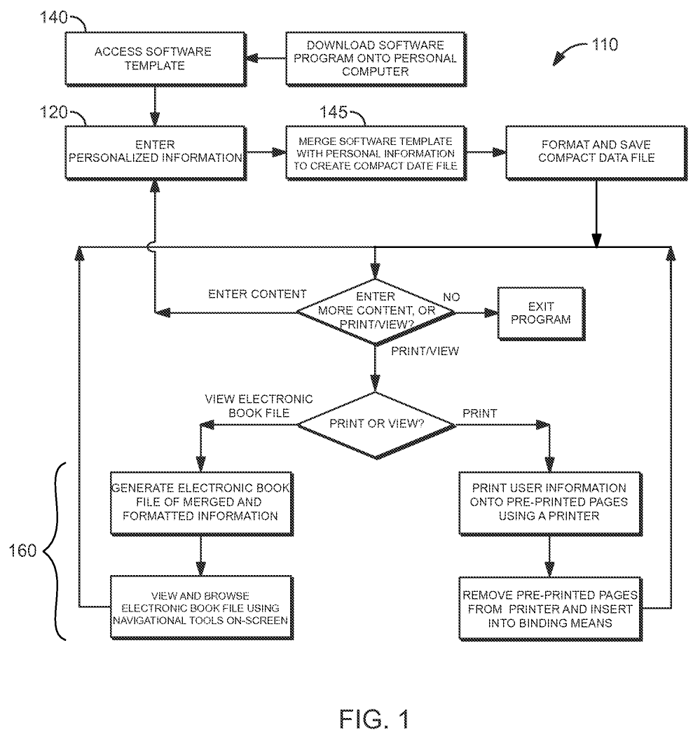

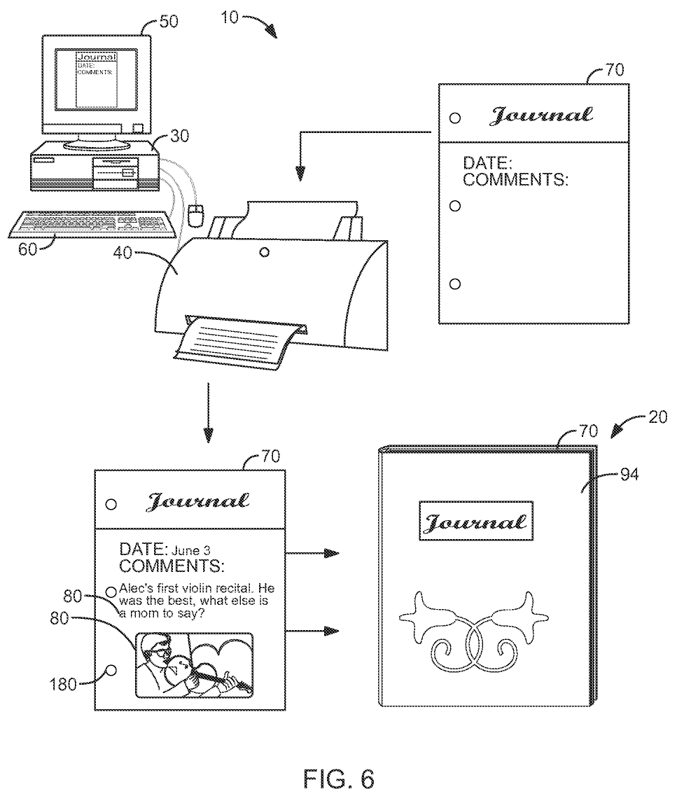

FIGS. 1 and 6 illustrate a system 10 for generating a semi-custom book 20 by utilizing a computer 30 that is connected to at least a monitor 50, at least one input device 60 such as a keyboard or a mouse (FIG. 6), or the like, and optionally a printer 40. Such a computer 30 may be a Windows PC-based computer, an Apple Macintosh type computer, a remote Internet server (not shown), or the like.

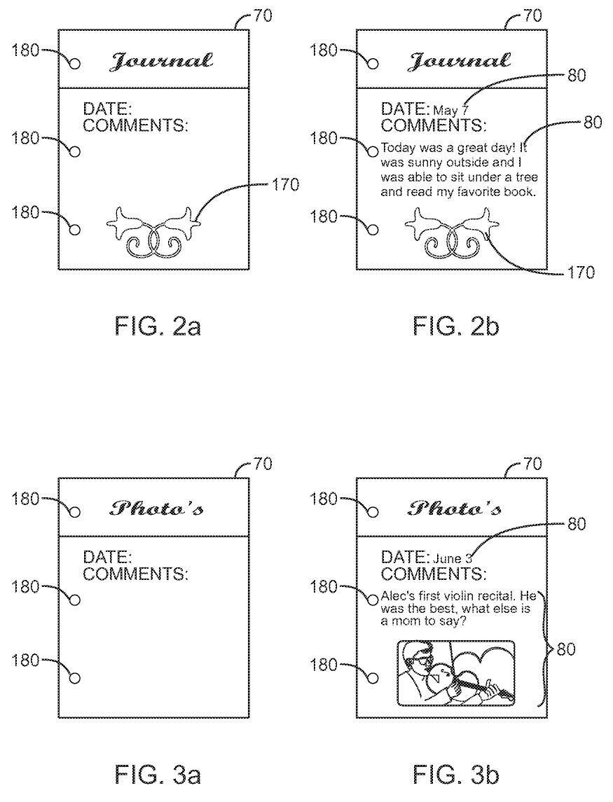

The system 10 includes a plurality of pre-printed pages 70 that are adapted for receiving printed images 80 from the printer 40. Such pre-printed pages 70 preferably relate to a common subject, color scheme, theme, or the like (FIGS. 2a, 2b, 3a and 3b). The pre-printed pages 70 are each adapted to fit into a standard ink-jet or laser computer printer 40, and may be standard letter size, legal size, A4 size, or the like.

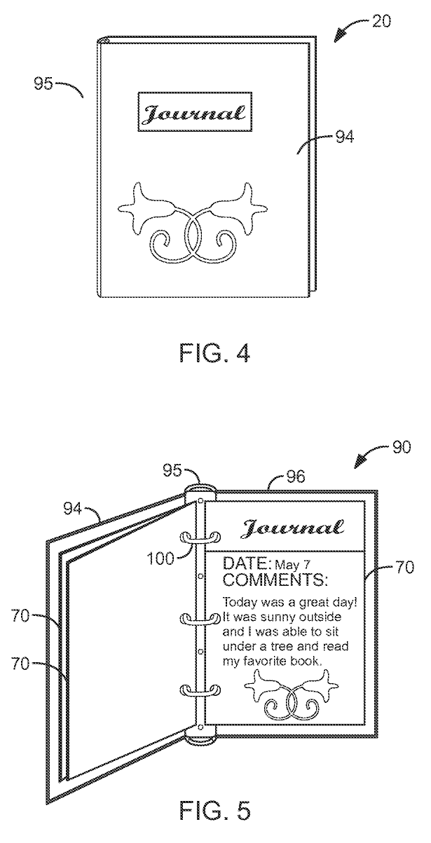

A binding means 100 is adapted to selectively hold each of the plurality of pre-printed pages 70 therein. The binding means 100 (FIG. 5) includes at least a front cover 94 (FIG. 4), a rear cover 96, and optionally a spine 95. Preferably each of the pre-printed pages 70 includes a plurality of binding aperture 180 (FIG. 2a), each of which cooperate with the binding means 100 to allow the binding means 100 to selectively hold at least two of the pre-printed pages 70 together. The binding means 100 may be, for example, a commonly-available three-ring type binder 90, or other type of binding means 100 that allows the user to selectively insert and remove any of the pre-printed pages 70.

The system 10 further includes a computer software program 110 adapted to receive information 120 that is entered by a user (not shown) into a software template 140, utilizing the computer 30, monitor 50 and the at least one input device 60. The template 140 includes a plurality of software pages 150 corresponding to a common subject, color scheme, theme, or the like. When the software program 110 displays certain of the software pages 150 on the computer monitor 50, the representation of each page 150 may correspond to at least one of the pre-printed pages 70. Preferably the user may edit each of the software pages 150 with the at least one input device 60 while the software page 150 is displayed on the monitor 50.

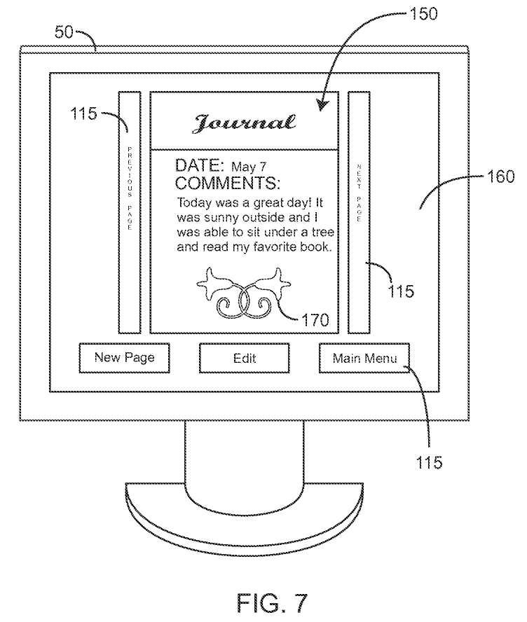

In use, the user is instructed to run the software program 110 on the computer 30 and to enter the information 120 into the software template 140 with the at least one input device 60. The user may enter the information 120 into either a compact data input page (not shown) that does not correspond to the look of any of the pre-printed pages 70, or directly on the software pages 150 (FIG. 7) that do at least partially correspond to the pre-printed pages 70.

Once at least a portion of the information 120 is entered into the software template 140, the software program 110 allows the user to save the information to a compact data file 145 (FIG. 1) to a storage device (not shown) of the computer 30 for future retrieval. The software program 110 also allows the user to print the information 120 onto the pre-printed pages 70. Thereafter, any of the pre-printed pages 70 with the information 120 printed thereon may be selectively inserted into the binding means 100 to make the book 20 (FIG. 4).

Alternately, such as in the case where the computer 30 does not have a printer 40 connected thereto, for example, the computer software program 110 allows the user to generate an electronic book file 160 that contains at least a portion of the information 120 entered by the user into the software pages 150. Preferably the electronic book file 160 may include at least a portion 170 of the information printed on the pre-printed pages 70, such that the electronic book file 160 may correspond to the pre-printed pages 70. Other software pages 150 may be available (not shown) that do not correspond to any of the pre-printed pages 70, giving the user additional flexibility in terms of the look and feel of the electronic book file 160. Such an electronic book file 160 may be in an editable portable document format (.pdf) file, or other graphic display electronic book file format that has navigation tools 115 to allow the user to display any of the software pages 150, either in-turn or directly (FIG. 7). Such an electronic book file is preferably editable with the input device 60 while displayed on the monitor 50.

Preferably each system 10 comes in a kit format that includes the binding means 100, the software program 110, and the pre-printed pages 70. Each kit may include pre-printed pages 70 and a corresponding software template 140 that pertain to a common subject, color scheme, theme, or the like. As each of the pre-printed pages are selectively removable from the binding means 100, the resulting book 20 may be a “living document,” that is, a book 20 wherein the information 120 therein can change over time as the user sees fit.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A system for generating a book by utilizing a computer connected to a printer, the system comprising:
a plurality of pre-printed pages adapted for receiving printed images from the printer;
a binding means for selectively holding the plurality of pre-printed pages therein, and further including at least a front cover and a rear cover;
a computer software program adapted to receive information entered by a user into a software template, the template including a plurality of software pages corresponding to a common subject, color scheme, or theme;
whereby the software program may print the information onto the pre-printed pages, any printed page then being selectively inserted into the binding means to make the book.

2. The system of claim 1 wherein the software program may output the information and the software template together into an electronic book file that contains at least a portion of the information entered by the user into the software template.

3. The system of claim 1 wherein each pre-printed page includes a plurality of binding apertures that cooperate with the binding means to selectively hold at least two of the pre-printed pages together.

4. The system of claim 1 wherein the computer includes a computer monitor and at least one input device connected thereto, and wherein the computer software program may display the plurality of software pages on the computer monitor and allow each of the plurality of software pages to be edited with the at least one input device directly.

5. The system of claim 1 wherein each of the plurality of software pages in the software template pertain to a common subject, color scheme, or theme.

6. A method for generating a book by utilizing a computer connected to a printer, the system comprising the steps of:
a) providing a plurality of pre-printed pages adapted for receiving printed images from the printer; a binding means for holding the plurality of pre-printed pages therein, and further including at least a front cover, and a rear cover; a computer software program adapted to receive information entered by a user into a software template, the template including a plurality of software pages corresponding to a common subject;
b) instructing a user to run the software program on the computer and to enter the information into the software template;
c) allowing the user to save the information as a master file within the computer; and
d) allowing the user to print the information onto the pre-printed pages and then to insert any number of the pre-printed pages into the binding means to make the book.

7. The method of claim 6 wherein step d) is replaced with:
allowing the user to generate an electronic book file that contains at least a portion of the information entered by the user into the software template.

8. A system for generating a book by utilizing a computer connected to a printer, the system comprising:
a plurality of pre-printed pages adapted for receiving printed images from the printer;
a binding means for selectively holding the plurality of pre-printed pages therein, and further including at least a front cover and a rear cover;
a computer software program adapted to receive information entered by a user into a software template, the template including a plurality of software pages corresponding to a common subject, color scheme, or theme;
whereby the software program may print the information onto the pre-printed pages, any printed page then being selectively inserted into the binding means to make the book.

9. The system of claim 8 wherein the software program may output the information and the software template together into an electronic book file that contains at least a portion of the information printed on the pre-printed pages.

10. The system of claim 8 wherein each of the plurality of software pages in the software template pertain to a common subject, color scheme, or theme.
